(19) United States
(12) Patent Application Publication
(10) Pub. No.: US 2021/0065313 A1
(43) Pub. Date: Mar. 4, 2021

(54) METHOD AND SYSTEM FOR INTERACTION WITH POLITICAL FIGURES

(71) Applicant: Klint South, Indianapolis, IN (US)

(72) Inventor: Klint South, Indianapolis, IN (US)

(21) Appl. No.: 17/003,490

(22) Filed: Aug. 26, 2020

Related U.S. Application Data
(60) Provisional application No. 62/891,512, filed on Aug. 26, 2019.

(51) Int. Cl. G06Q 50/00; G06Q 50/26; G06Q 10/10; G06Q 30/02; G06Q 10/08; G06N 3/04; G06F 40/289; G06F 40/186; G06F 40/174

(52) U.S. Cl. CPC G06Q 50/01; G06Q 50/265; G06Q 10/105; G06Q 30/0203; G06Q 30/0205; G06F 3/0482; G06N 3/04; G06F 40/289; G06F 40/186; G06F 40/174; G06Q 2230/00; G06Q 10/083

(57) ABSTRACT

A method and system are disclosed which calculates a consistency score for a political figure based on social media, speeches, news articles, or other information sources, as well as the political figure's voting record. The method and system determine the political representatives for a user based on the user's geographical location, and present information on various political figures to the user. The method and system are also capable of providing communication between multiple users, as well as between users and political figures. The method and system also allow for users to send physical letters to political figures, and for political figures to send messages to users.

### CROSS-REFERENCE TO RELATED APPLICATIONS

The present application claims the benefit of and prior to U.S. Provisional Application No. 62/89,1512, entitled “METHOD AND SYSTEM FOR INTERACTION WITH POLITICAL FIGURES,” filed on Aug. 26, 2019, the entire contents of which being hereby expressly incorporated herein by reference.

### FIELD OF THE DISCLOSURE

The present disclosure generally relates to methods and systems for providing information on and interacting with political figures, and more particularly to methods and systems for providing information on a political figure's public stances and voting record, as well as providing a means for effective communication between political figures and their constituents.

### BACKGROUND OF THE DISCLOSURE

When evaluating their political representatives or entering a new election season, voting constituents want as much accurate information as possible. Often in political campaigns or live debates, politicians or media sources will claim that an opposing politician acted disingenuously and voted on an issue in way that contradicts their public stance on that issue. The burden is then placed on the viewers or voting constituents to validate that claim on their own, which is often difficult due to the length and complexity of legislative bills.

Furthermore, voting constituents often seek ways of effectively communicating with their representatives to express their opinions relating to current events, upcoming votes, or similar issues. Often, the most convenient way to send communication to a political representative is through email, but emails are often disregarded by the representative's office. Physical letters are often a more effective way to communicate with a political figure, but they require additional time, effort, and resources when compared to an email. Political figures in turn also seek means to communicate with their constituents. It is often in the politician's best interest to ask their constituents about their views on a certain topic and to obtain information related to who their constituents are. Social media provides a platform for politicians to post polls or ask for responses, but these can be answered by anyone on the internet, and often do not provide the representative with all the information they need.

As such, it is desirable to provide an efficient, automated system for identifying a political figure's public stance and voting record on a given issue, comparing their public stance to their voting record, and providing a representation of this comparison to a user. It is also desirable to provide a platform for effective communication between political figures and their constituents, including a system to efficiently send communications to representatives, and for representatives to receive information about their constituents.

### SUMMARY OF THE INVENTION

In one embodiment, the present disclosure provides a computer-implemented method for providing a user with information on political figures that represent the user, the method comprising: receiving data from a user, the data comprising at least a location of the user and demographic information of the user; determining at least one first political figure that represents the user in at least one of a local, state, and federal government based on the location of the user and data provided by the at least one of the local, state, and federal government; identifying through natural language processing at least one key phrase from at least one of social media posts, speech text, and news articles related to the at least one first political figure; assigning the at least one key phrase to a predetermined issue; identifying through natural language processing a number of modifying words near the at least one key phrase; calculating an issue score for the predetermined issue based at least partially on the at least one key phrase and the number of modifying words, wherein the issue score represents the belief of the at least one first political figure about the predetermined issue; identifying through natural language processing the predetermined issue within a public bill; determining a voting record of the at least one first political figure on the public bill; calculating a weighted voting record for the predetermined issue based at least partially on a comparison between the predetermined issue within the public bill and the voting record of the at least one first political figure on the public bill; generating, by a neural network, a consistency score based at least partially on the issue score and the weighted voting record; and providing to the user a first graphical display representing the consistency score for the at least one first political figure. In one aspect of this embodiment, the method further comprises selecting by a user at least one second political figure, wherein the at least one second political figure does not necessarily represent the user in at least one of a local, state, and federal government; and providing to the user a second graphical display representing a consistency score for the at least one second political figure. Another aspect further comprises providing the at least one political figure with the location and demographic information of the user, the demographic information including at least one of the user's name, age, race, ethnicity, gender, voting history, income level, marital status, or political beliefs. Still another aspect further comprises displaying at least one question to the user related to a political issue; receiving a response to the question from the user; displaying the response to the at least one first political figure. In another aspect, the issue score comprises at least one scale value representing whether the at least one first political figure is outwardly positive or negative towards the predetermined issue, and at least one magnitude value representing how strongly the at least one first political figure outwardly presents their opinions on the predetermined issue. In a variant of this aspect, the at least one scale value ranges from negative one to positive one, and the at least one magnitude value is a positive integer. Yet another aspect of this embodiment further comprises providing the user with a text template; receiving a number of edits to the text template from the user to create a final text; printing the final text onto a physical medium; and sending the physical medium with the final text to the at least one first political figure. Another aspect further comprises providing the user with a second graphical display representing the issue score. In a variant of this aspect, the second graphical display is a thermometer.

In another embodiment, the present disclosure provides a computer-implemented method for providing communication between a user and a political figure, the method comprising: providing the user with a number of information entry fields; receiving from the user a first set of information in the number of entry fields, the first set of information including at least one of the user's name, location, political party, and gender; storing the first set of information in a database; generating a user account for the user, wherein the user account is associated with the first set of information; selecting by the user at least one political figure; providing to the user a profile for the at least one political figure; providing to the user a question from the at least one political figure; receiving a response from the user to the question, and sending the response to the at least one political figure; receiving a message from the at least one political figure, the message comprising at least one of text, video, and audio; displaying the message to the user; and displaying at least one meter to the user in the profile for the at least one political figure, the at least one meter representing at least one of a consistency score and a weighted issue score for the at least one political figure, wherein the consistency score and weighted issue score are calculated by a neural network algorithm based on information from a number of social media posts related to the at least one political figure. One aspect of this embodiment further comprises sending to the at least one political figure a physical letter, wherein the physical letter comprises text at least partially taken from a template. Another aspect further comprises displaying an issue table on the user profile for the at least one political figure, the issue table comprising a number of issues and a stance and a vote number associated with each issue. In a variant of this aspect, the issue is selectable, and selecting the issue provides the user with an issue description, the issue description containing information related to a stance of the at least one political figure related to the issue.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is an exemplary embodiment of a communication system;

FIG. 2 is an exemplary embodiment of the analysis system of the communication system of FIG. 1;

FIG. 3 is an exemplary method for calculating and displaying a weighted issue score for a political figure;

FIG. 4 is an exemplary method for calculating and displaying a weighted voting record for a political figure;

FIG. 5 is an exemplary method for calculating and displaying a consistency score for a political figure;

FIG. 6 is an exemplary method for sending a letter to a political figure; and

FIGS. 7-22 are each different screens of an exemplary user interface for a user device connected to the communication system of FIG. 1.

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION OF THE DRAWINGS

The detailed descriptions which follow are presented in part in terms of algorithms and symbolic representations of operations on data bits within a computer memory representing alphanumeric characters or other information. These descriptions and representations are the means used by those skilled in the art of data processing to most effectively convey the substance of their work to others skilled in the art.

An algorithm is here, and generally, conceived to be a sequence of steps leading to a desired result. These steps are those requiring physical manipulations of physical quantities. Usually, though not necessarily, these quantities take the form of non-transient electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data management processing systems and are not accessible except through sophisticated software systems. Data structures are not the information content of a memory. Rather, they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. That is not the case for any of the operations described herein which form part of the present disclosure; the operations are machine operations. Useful machines for performing the operations of the present disclosure include general purpose digital computers of other similar devices. In all cases the distinction between the method operations in operating a computer and the method of computation itself should be recognized. The present disclosure included methods and apparatuses for operating a computer in processing electrical or other non-transient physical signals to generate other desired, non-transient physical signals.

The present disclosure also relates to a system of devices for performing these operations. These devices may be specifically constructed for the required purposes of may comprise a general purpose computer as selectively activated or reconfigured by a computer program executed by the computer. The algorithms presented herein are not inherently related to any particular computer or other apparatus. In particular, various general purpose machines may be used with programs written in accordance with the teachings herein, or it may prove more convenient to construct more specialized computing devices to perform the required method steps. The required structure for a variety of these machines will appear from the description below.

Both the programs and databases disclosed herein may be objects in an object-oriented system. The actual physical implementation of a database on a general purpose computer may take several forms, from complete individual records storing the substantive information with several key indexes for locating a particular record, to a plurality of tables interrelated by relational operations, to a matrix of cross-linked data records, to various combinations and hybrids of these general types. In particular physical devices, a database may be structured and arranged to accommodate the restrictions of the physical device—but when transferred to a general purpose computer be able to be stored in a variety of formats. Thus, while certain types of information may be described as being stored in a “database” from a conceptual standpoint, generally such information may be electronically stored in a variety of structures with a variety of encoding techniques.

Databases may contain many types of information, and may store the information in a variety of encoding techniques. When a database stores information that relates to a particular person, condition, location, or other thing, the database typically uses a unique identifier that binds the “concept” of the person, condition, location, or other thing with a storable piece of data. When the unique identifier is used to reference the data record, the unique identifier may be termed a “key” and data records associated with the “concept” are said to be “keyed” by the unique identifier. The association between a key and its data may be implemented in a variety of ways, for example by having the key be a field in a corresponding data record, by having a key value in a search tree with an associated pointer to one of more data records corresponding to the key, or by encoding the corresponding information with a value that upon decoding produces the unique identifier and the corresponding data, etc. By these various methods, instances of data may be associated with, or “bound” with or to the “concept” by using the key.

The terms “network,” “local area network,” “LAN,” “wide area network,” or “WAN” mean two or more computing devices which are connected in such a manner that information may be transmitted between the computing devices. In such computer networks, typically one or more computing devices operate as a “server,” a computer with large storage devices such as hard disk drives and communication hardware to operate peripheral devices such as printers or modems. Other computing devices, sometimes called “workstations,” provide a user interface so that users of computer networks can access the network resources, such as shared data files, common peripheral devices, and inter-workstation communication. The computing devices have at least one processor for executing machine instructions, and memory for storing instructions and other information. Many combinations of processing circuitry and information storing equipment are known by those of ordinary skill in these arts. A processor may be a microprocessor, a digital sensor processor (“DSP”), a central processing unit (“CPU”), or other circuit or equivalent capable of interpreting instructions and/or performing logical actions on information. Memory includes both volatile and non-volatile memory, including temporary and cache, in electronic, magnetic, optical, or other format used to store information. Users activate computer programs or network resources to create “processes” which include both the general operation of the computer program along with specific operating characteristics determined by input variables and its environment.

### Communication System

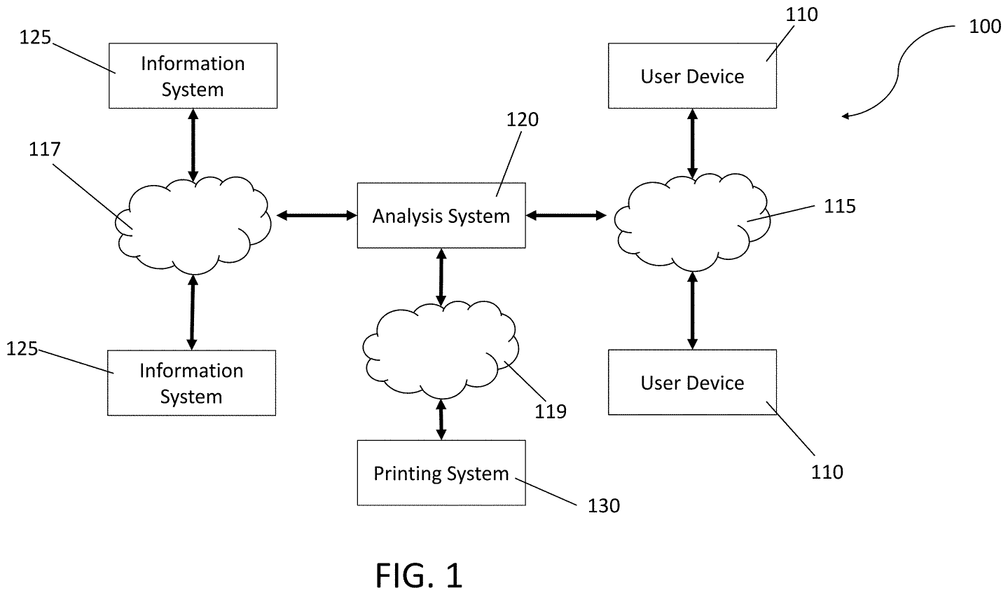

Referring to FIG. 1, a communication system 100 according to one embodiment of the present disclosure is shown. Communication system 100 comprises at least one user device 110 in communication with an analysis system 120 through network 115. The user device 110 can be any computer system with at least one processor to be operated by a user. Examples of user device 110 include cell phones, tablets, personal computers, e-readers, and similar devices. Analysis system 120 is also in communication with at least one information system 125 (two shown) through network 117 and with at least one printing system 130 through network 119. As will be understood by those skilled in the art, at least portions of networks 115, 117, 119 may be the same network. In general, and as described in greater detail below, analysis system 120 communicates with information system 125 to receive data related to political figures and to analyze that data. Analysis system 120 communicates with user device 110 to receive user data, analyze user data, and send data to user device 110.

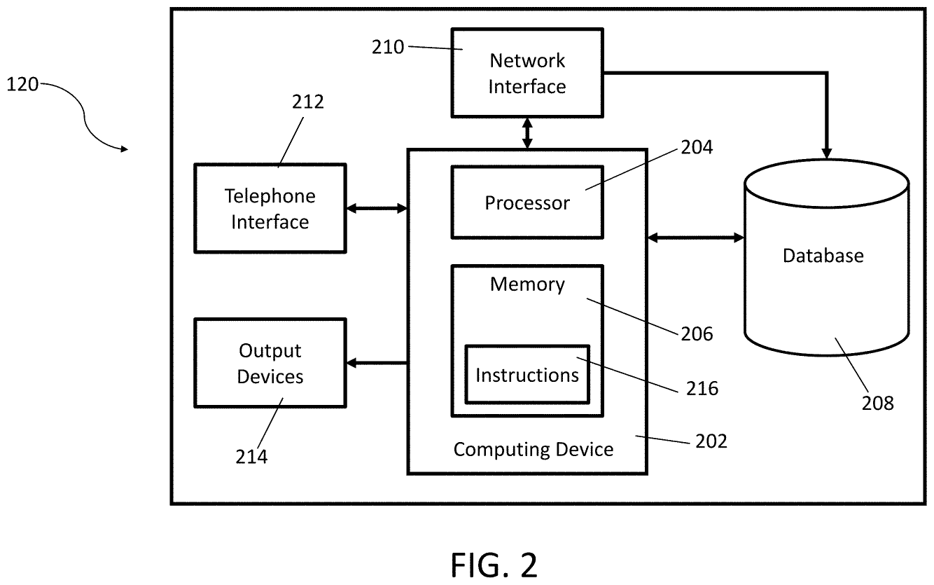

Analysis system 120 is depicted in further detail in FIG. 2. In an exemplary embodiment, analysis system 120 generally includes a computing device 202 including a processor 204 and a memory 206, a database 208, a network interface 210, a telephone interface 212, and one or more output devices 214. Additionally, memory 206 of analysis system 120 includes a plurality of machine-readable instructions 216 which form structural elements of memory 206 and which, when executed by processor 204, cause computing device 202 to perform the plurality of functions described herein.

While analysis system 120 is depicted as a singular entity, it will be understood by those skilled in the art that analysis system 120 may be implemented as multiple entities, in a distributed network or other suitable fashion wherein the various structural and functional characteristics of analysis system 120 are performed in different locations and/or by different devices. Similarly, it should be understood that computing device 202 of analysis system 120 may be implemented using multiple computing devices, such as multiple personal computing devices, multiple workstations, and/or multiple servers, and that each computing device 202 may include more than one processor 204 and/or more than one memory 206. Likewise, while database 208 is referred to herein as a central database functioning as a repository for a variety of different data items and data structures, database 208 may be implemented as a distributed database wherein certain database items are stored in one location and other database items are stored in one or more other locations. Additionally, or in the alternative, database items may be stored redundantly in two or more databases 208. Also, analysis system 120 may include a plurality of network interfaces 210 and/or a plurality of telephone interfaces 212. In accordance with the foregoing, the connecting lines in FIG. 2 between the various components of analysis system 120 are intended to depict any suitable operational connection, including, but not limited to, direct and indirect wired connections and wireless connections either within a closed system or over one or more networks.

Each of analysis system 120, user device 110, and information system 125 may carry out the specified functions described herein in a manner consistent with the operation of a conventional computing system programmed with instructions for performing the specified functions, which will be described in detail below.

### Political Figure Scores

In an exemplary embodiment of the present disclosure, analysis system 120 receives information related to political figures from information system 125, and analyzes and compares the received information in order to calculate an issue score, a weighted voting record, and a consistency score to be displayed to a user. In the present disclosure, a political figure is any person associated with a governing body, including, but not limited to, members of congress, governors, mayors, judiciaries, presidents, prime ministers, cabinet members, members of parliament, and similar officials. Furthermore, political figures may be candidates running for elected positions in any political office. The political figures may be representatives from any of local, county, provincial, state, federal or any other level of government.

Furthermore, information system 125 can be any database, server, website, repository, computer system, or other source of information that is capable of providing information related to a political figure or public affairs. Exemplary forms of information system 125 include social media databases, public voting record databases, news databases, speech records, public legislation, political figure websites, campaign websites, and similar sources of public information.

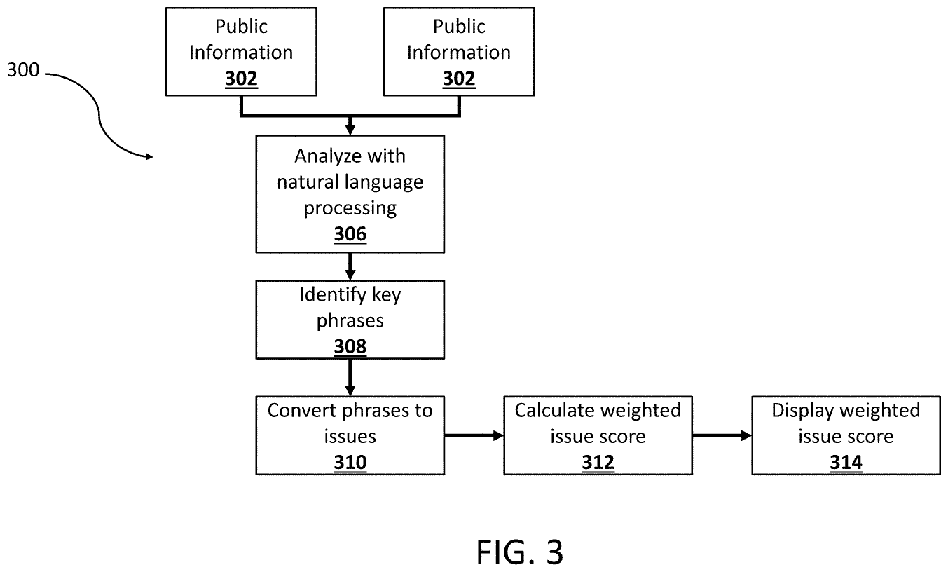

Referring now to FIG. 3, an exemplary method 300 for calculating and displaying a weighted issue score for a political figure is shown. Analysis system 120 receives public information 302 related to a political figure from information system 125. Public information 302 can include social media posts, speeches, statements, and broadcasts made by a political figure. Public information can also include news articles, blog posts, opinions, analyses, and social media posts about a political figure from other parties. In one embodiment, public information 302 consists of public statements made online by the political figure relating to various issues or topics with political relevance. For example, public information 302 may include information related to the political figure's stance on an issue to be voted on, or on a topic of concern for the political figure's constituents. When public information 302 comes from a speech made by a political figure or relating to a political figure, the text from the speech can be pulled from a database in information system 125 containing the text version of the speech, or the text may be pulled from the speech using speech-to-text language processing as is known in the art. While two sources of public information 302 are shown, method 300 can be utilized using only one source of public information 302 or many more than two sources. In an exemplary embodiment, public information 302 includes social media posts and speech text.

Analysis system 120 takes the text form public information 302 and analyzes the text with natural language processing (block 306) to determine the specific issue or topic of discussion in public information 302. A piece of public information may contain multiple issues, which can be identified and separated by analysis system 120. Key phrases are identified by analysis system 120 (block 308) by identifying a specific noun or verb within the analyzed text as the key phrase, and identifying modifying words or phrases surrounding the key phrase. The key phrase or phrases are then converted to a specific issue, usually a single word or phrase (block 310). Various similar key phrases can be combined into a single issue. For example, the phrases “POTUS”, “Mr. President”, “The leader of the country”, and “commander in chief” could all be combined into the single issue of “U.S. President”.

A weighted issue score is then calculated (block 312) based on the identified issue and modifying words surrounding the key phrases identified. In the exemplary embodiment, the weighted issue score contains a positive/negative scale value and a magnitude value. The positive/negative scale value ranges from −1 to +1 and indicates whether the political figure's stance on an issue is positive or negative. The weighted issue score also contains a magnitude value, which is a positive integer value representing how strong the political figure's stance is on the issue. In the illustrated embodiment, the larger the magnitude value, the stronger the political figure's stance is on the issue. In other embodiments, different scales and representations of the political figure's stance on an issue may be used.

For example, if a political figure were to describe an issue as “not bad”, “okay”, “somewhat decent”, and “slightly above average”, then the political figure would most likely have a positive/negative scale value greater than zero since they feel generally positive about the issue, and would have a relatively low magnitude value compared to a figure who felt more strongly about the issue at hand, since the modifiers used by the political figure were relatively weak. Alternatively, if a political figure described an issue as “horrendous”, “absolutely terrible”, “entirely dysfunctional”, and “a mess”, then the political figure would most likely have a positive/negative scale value less than zero since they feel generally negative about the issue, and would have a relatively large magnitude value compared to a figure who felt less strongly about the issue at hand.

Each political figure can have a different positive/negative scale value and a different magnitude value for each issue. The issues to be analyzed can be determined by operators of analysis system 120. In other embodiments, analysis system 120 can review information related to a political figure throughout recent history, and can calculate a weighted issue score for a political figure over various time periods. In another embodiment, analysis system 120 may pull information from news articles, blog posts, political websites, political advertisements, or other sources of information in addition to or instead of pulling information from social media posts and/or speech text. The weighted issue score can then be displayed to a user (block 314) as described in greater detail in the “User Interface” section below.

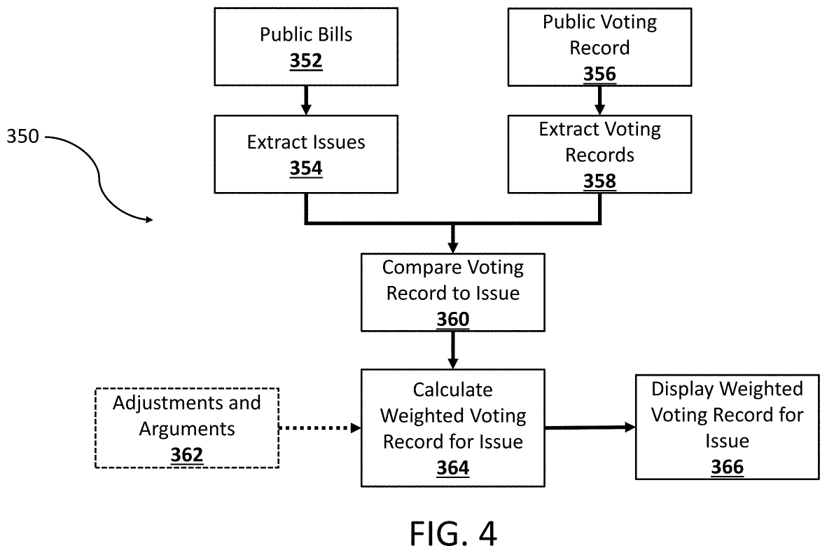

Referring now to FIG. 4, an exemplary method 350 for calculating and displaying a weighted voting record for an issue for a political figure is shown. Analysis system 120 extracts issues from public bills voted on by political figures (blocks 352 and 354). The public bills can be any official order, law, bill, legislation, written opinion, contract, declaration, or any other official public document signed, voted for, or otherwise officially supported by a political figure. The public bills can come from public records posted online, and the issues can be extracted from the bills through natural language processing. In another embodiment, the issues are extracted from the bills by analysis of experts and political analysts in online publications or news articles, and the issues are then received by analysis system 120 using natural language processing.

Analysis system 120 also extracts the voting record of a political figure from public voting records (blocks 356 and 358). The voting record of a political figure can be any record of the bills or laws the political figure has voted on or officially supported, orders or legislation they have signed, or any other official indication of support or opposition to public bills. In extracting the voting record from publicly available voting records, analysis system 120 determines how a political figure officially supported or opposed a public bill. In an illustrative embodiment, the public voting record can be congressional voting records, and analysis system 120 can extract the voting record for a political figure for the bills voted on while the political figure was in office. Analysis system 120 would then determine whether the political figure voted for or against each bill.

Analysis system 120 then compares the voting record of a political figure to the issues extracted from the bills voted on (block 360). For example, if a bill supporting gerrymandering were voted on in congress, and a political figure voted for the bill, then analysis system 120 would determine that the political figure voted in a manner that was in support of gerrymandering.

Analysis system 120 then calculates a weighted voting record for an issue for a political figure (block 364). The weighted voting record is a numerical representation of how the political figure voted on a particular issue. The weighted voting record can be similar in nature to the weighted issue score, containing a positive/negative scale value, and a magnitude value. In other embodiments, various numerical representations may be used. A political figure can make adjustments and arguments (optional block 362) relating to their voting record by submitting statements to analysis system 120. Such statements can include written statements, video or audio recordings, and similar methods of communication which can also be communicated to user devices 110. Adjustments and arguments can provide reasoning as to why a political figure voted on a public bill in the way that they did and can alter the weighted voting record for an issue for a political figure who submits adjustments and arguments.

For example, a public bill may contain multiple issues, and a political figure may vote against the bill because the political figure opposes one of the issues. The political figure may be in support of the other issues contained in the bill. Accordingly, the political figure can submit adjustments and arguments to provide additional information that explains which issues in the bill they supported, and which they opposed. Analysis system 120 can then alter the weighted voting record for the issue based on the received adjustments and arguments.

In the illustrated embodiment, the weighted voting record for the issue is displayed for a political figure (block 366) as described greater detail in the section “User Interface” below.

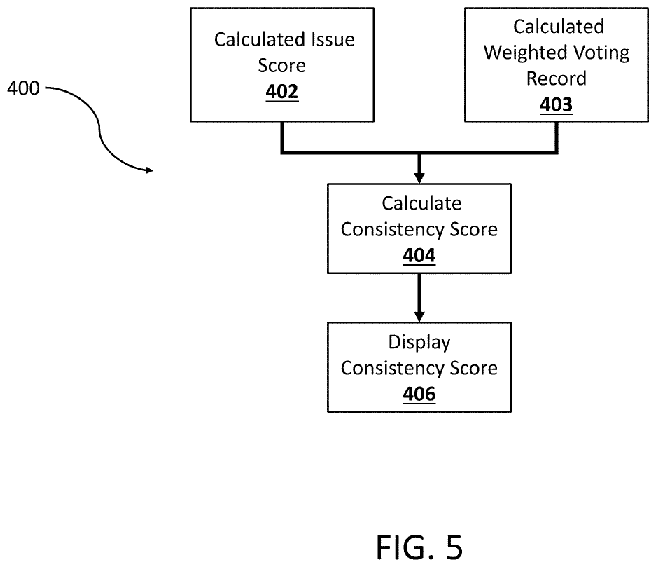

Referring now to FIG. 5, an exemplary method of calculating and displaying a consistency score is shown. The weighted issue score from method 300 and the weighted voting record from method 350 are compared to one another by analysis system 120 (block 404). In this step, the analysis system 120 calculates a consistency score representing how well a political figure's public statements align with the political figure's voting record by using a neural network. The consistency score can be calculated for a single issue, or for the political figure as a whole.

The consistency score is represented by at least one numerical value. Similar to the above-mentioned weighted issue score, the consistency score can be comprised of a positive/negative scale value and a magnitude value. In an illustrative embodiment, the positive/negative scale value ranges from −1 to +1, wherein a +1 indicates that the political figure votes exactly the same way as their public statements would indicate, and a −1 indicates that the political figure votes exactly the opposite of what their public statements would indicate. The magnitude value is a positive integer value that indicates how strongly the political figure's voting record agrees or disagrees with their public statements based on the magnitudes of the weighted issue score and the weighted voting record. In other embodiments, the consistency score can be represented by any numerical system. The calculated consistency score can then be displayed (bock 406) as described in further detail in the section “User Interface” below.

The combination of methods 300, 350, and 400 of FIGS. 3-5 provide an overall method to determine whether or not a political figure actually votes in alignment with the beliefs they claim to have. Accordingly, it provides a system for voting constituents to check whether their current or potential representatives act honestly, and to see which issues matter the most to a political figure. Due to the complexity and volume of public bills, social media posts, speeches, and voting records, it would be essentially impossible for a person to complete the analysis outlined in the methods described and run by analysis system 120. It would be especially impossible for a person to complete said analysis with efficiency or in a short period of time for any political figure.

### Communication Between Political Figures and Users

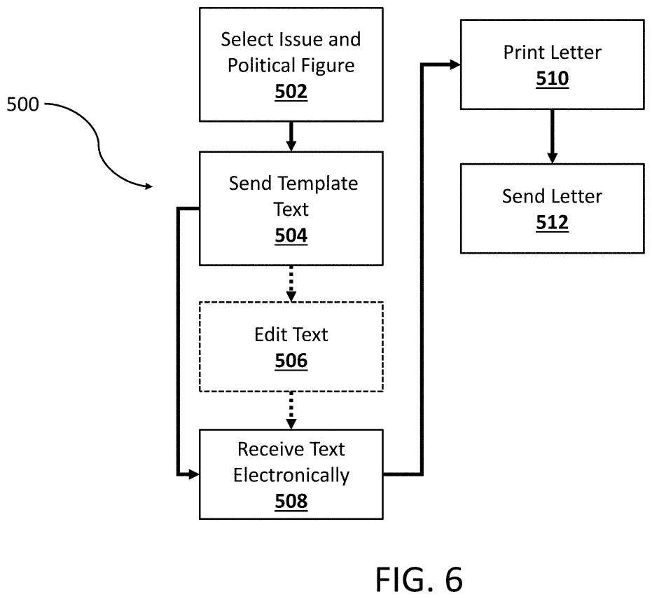

Referring now to FIG. 6, an exemplary method 500 for a letter to be sent to a political figure is shown. According to method 500, a user can communicate with a political figure by sending a physical letter, as opposed to a fax, email, or phone call. First a user selects a particular issue to address and a particular political figure to send the letter to (block 502). The issue and political figure can be selected from a list inputted and/or selected by the user through user device 110. The user can also select a stance regarding the selected issue (e.g., for or against). Following the various selections by the user, the analysis system 120 sends a message template to be received by the user (block 504). The template contains boilerplate text reflecting the user-selected issue and stance and addresses the selected political figure. The template can be varied depending on at least the issue, stance, or office of the political figure. The user has the option to edit the template by adding, subtracting, or altering the text from the template (optional block 506).

The final text to be written on the letter is then sent to analysis system 120 (block 508) optionally including information about the user. The user information can be the user's name, signature, location, gender, sexual identity, race, political party, or any other piece of demographic information. When the text is sent from the user device 110 through network 115 to analysis system 120, the text is sent to printing system 130 through network 119 and then printed onto a physical piece of paper or similar physical medium (block 510), then the letter is sealed in an envelope and sent to the selected political figures. Printing system 130 can be any system used to print text onto physical medium, including electronic printers as are known in the art. In one embodiment, the user can send multiple letters to multiple different political figures at once. In another embodiment, the multiple letters are sent from multiple users to a single political figure at once in a bundle.

Communication system 100 also allows for communication from a political figure to a user through at least network 117 and user device 110. A political figure can send messages through network 117 to analysis system 120, which then can send the messages to user device 110. The message can be in the form of text, video, audio, or other digital communication means. The political figure can send a message to address their constituents, address a topic, present their view on a topic, address their recent actions, or to communicate any desired topic with a user. Furthermore, a political figure can send questions or polls to users. These questions or polls can provide the political figure with information on how their constituents feel about a certain issue, a recent event, the political figure's performance, or other topics. Accordingly, the political figure can have a better understanding of the views of their constituents.

### User Demographic Information

Upon registering to use the communication system 100, a user will be prompted on the user device 110 to input demographic data. The demographic data can include, but is not limited to, the user's name, location, age, race, ethnicity, gender, sexual orientation, sexual identity, income levels, marital status, parental status, political party affiliation, voting history, and political figure preferences. The user's location may be input by the user, or may be taken directly from GPS, satellite, or network information containing the user's location. The analysis system 120 can receive the demographic information and use the information to connect multiple users through multiple user devices 110 and at least network 115. Accordingly, a user can be provided with at least some of the demographic information of another user. In one embodiment, a user can view a list of other users in a similar area with similar political beliefs.

Furthermore, analysis system 120 can take user demographic data (e.g., location) and information from information system 125 to determine which political figures represent the user based on geographical location and to present said political figures to the user. In one embodiment, analysis system 120 can also determine which, if any, political figures are running for office within that geographical location and present those political figures to the user. Analysis system 120 can also provide a political figure with at least some of the demographic data representing their constituents.

### User Interface

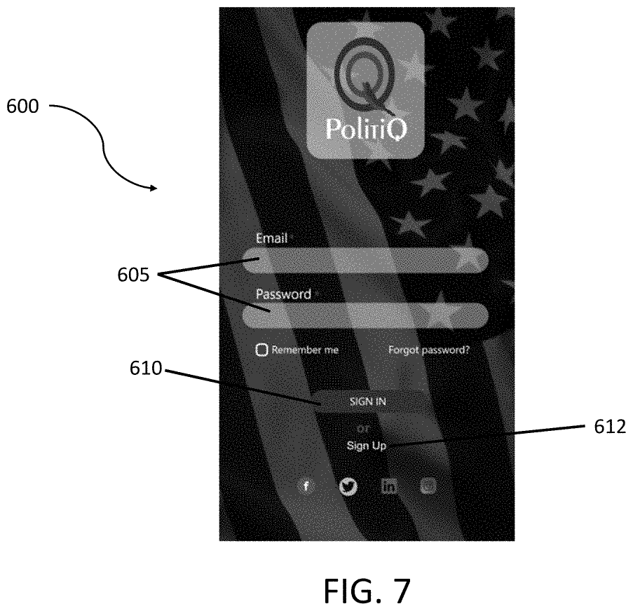

FIGS. 7-22 show multiple screens within an exemplary user interface to be shown on user device 110 when using communication system 100. In an exemplary embodiment, the user interface is an application capable of being downloaded onto a user device 110 containing code capable of being run on user device 110. While the illustrated user interface is an exemplary embodiment, it is understood that variations on the illustrated interface may be utilized. For example, the style, fonts, colors, images, and overall layout of the user interface may be varied. Furthermore, the selectable options in the illustrated user interface are not limited to those shown and may include more or fewer options for a user to select. Additionally, the illustrated user interface is shown using the names and likenesses of specific individuals, as well as news stories, stances, opinions, biographies, demographic information, and voting records related to specific individuals. The illustration of the various aspects related to specific individuals is not intended to be limiting, but rather to show examples of how communication system 100 may be utilized to carry out the objects of the present application. In practice, communication system 100 can be used with any number of users and political figures.

Throughout the description of the illustrated user interface, reference is made to “selecting” options by a user. Selection in this context is intended to encompass any form of selection known in the art, including but not limited to clicking with a mouse, tapping on a screen, or using voice commands or physical gestures. Furthermore, elements of user interface are described as “buttons” or “links”, which are meant to be construed as typical terms of the art, encompassing any form of a selectable option to activate, continue, or stop a processor of user device 110 from running various elements of computer code related to the user interface.

FIG. 7 shows a login screen 600 for a user to log in to communication system 100. The illustrated embodiment comprises login fields 605 for a user to input an email and password to login if the user already has an account to use communication system 100. In other embodiments, login credentials other than an email and a password may be used, including usernames, biometric information, and similar login means as are known in the art. Once login fields 605 have been appropriately filled, the user can select the sign in button 610 to provide the user with access to communication system 100. If a user does not already have an account for communication system 100, the user can select the sign up button 612 to create an account. Selecting the sign up button 612 will take the user to the sign up screen 620.

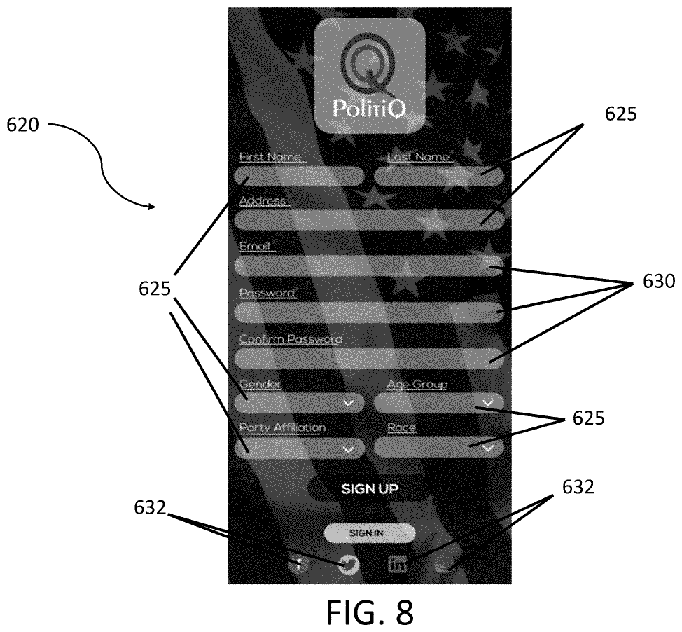

As shown in FIG. 8, sign up screen 620 includes a plurality of demographic information input fields 625 and login information input fields 630. Demographic information input fields 625 allow the user to input demographic information including name, address, age, gender, race, party affiliation, or other descriptors. Demographic information input fields 625 can consist of any combination and any number of dropdown menus, text inputs, checkboxes, or other information input means. Login information input fields 630 allow the user to input login information including an email address, password, username, or other means for providing the user access to communication system 100. Any number of both demographic information input fields 625 and login information input fields 630 may be required to complete the sign-up process. Demographic and login information can be stored in database 208 of analysis system 120. Required fields may be indicated by the presence of a visual indicator, such as an asterisk or other indication means. The user also has the option of connecting their social media accounts to communication system 100. Communication system is capable of communicating with social media networks through at least network 117 through methods known in the art. The user can select to communicate with social media networks through social media buttons 632.

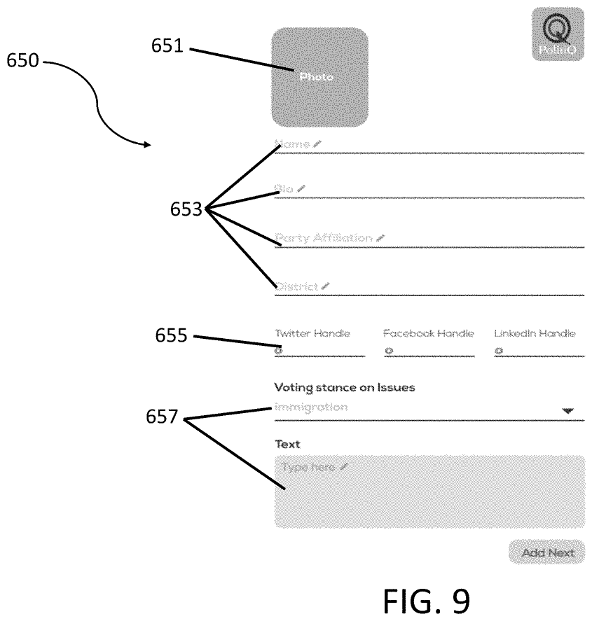

Referring now to FIG. 9, a profile editing screen 650 is shown. The user may be prompted to enter the profile editing screen 650 upon leaving sign up screen 620. In the illustrated embodiment, profile editing screen 650 comprises a photo field 651, public input fields 653, social media input fields 655, and stance input fields 657. In other embodiments, the number and type of input fields may vary. Photo field 651 allows a user to upload a picture to represent the user on the communication system 100. Public input fields 653 allow a user to input information to be displayed to other users through communication system 100 including, but not limited to, name, a biographical summary (bio), party affiliation, or political district. Social media input fields 655 allow a user to input usernames, handles, pages, or other identifiers related to social media websites or networks. Stance input fields 657 allow a user to select a topic and to describe their voting stance on the selected topic. In the illustrated embodiment, the information entered into the fields of profile editing screen 650 are able to be seen by other users through communication system 100.

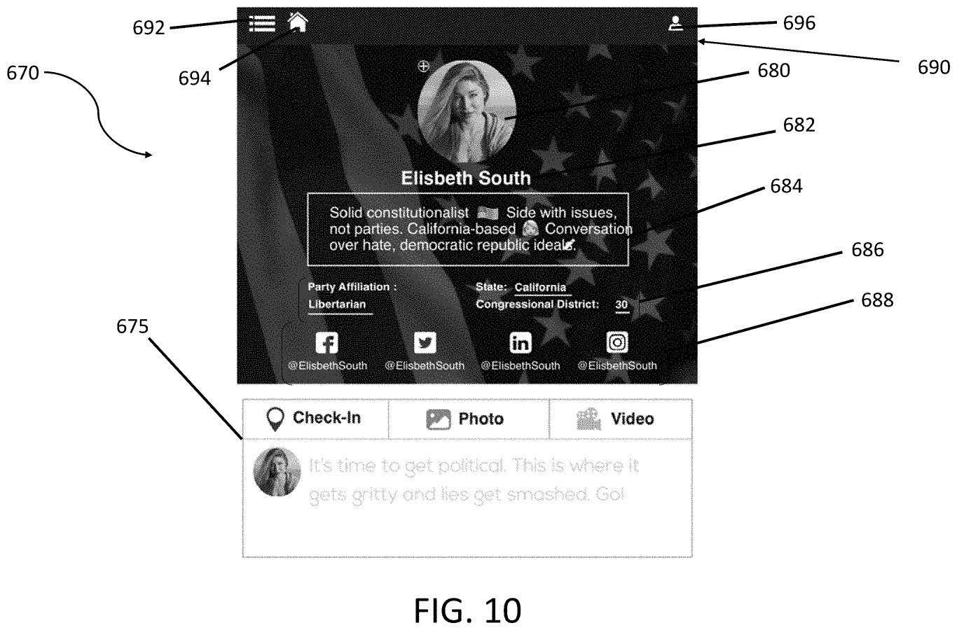

The completed user profile can be seen in FIG. 10, which shows the user profile screen 670. User profile screen 670 comprises a live input section 675, photo 680, name 682, bio 684, demographic information 686, and social media information 688. Live input section 675 allows the user to send messages, pictures, location information, videos, or other communications out to communication system 100 to be viewed by other users. Photo 680, name 682, bio 684, demographic information 686, and social media information 688 can be input by the user in profile editing screen 650. In the illustrated embodiment, user profile screen 670 is viewable by other users through communication system 100.

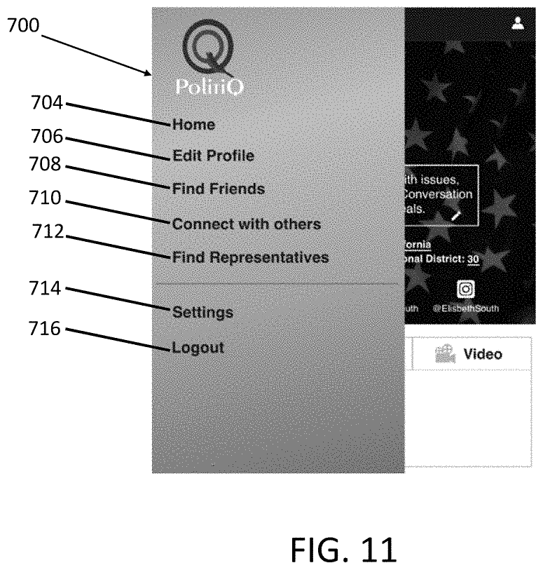

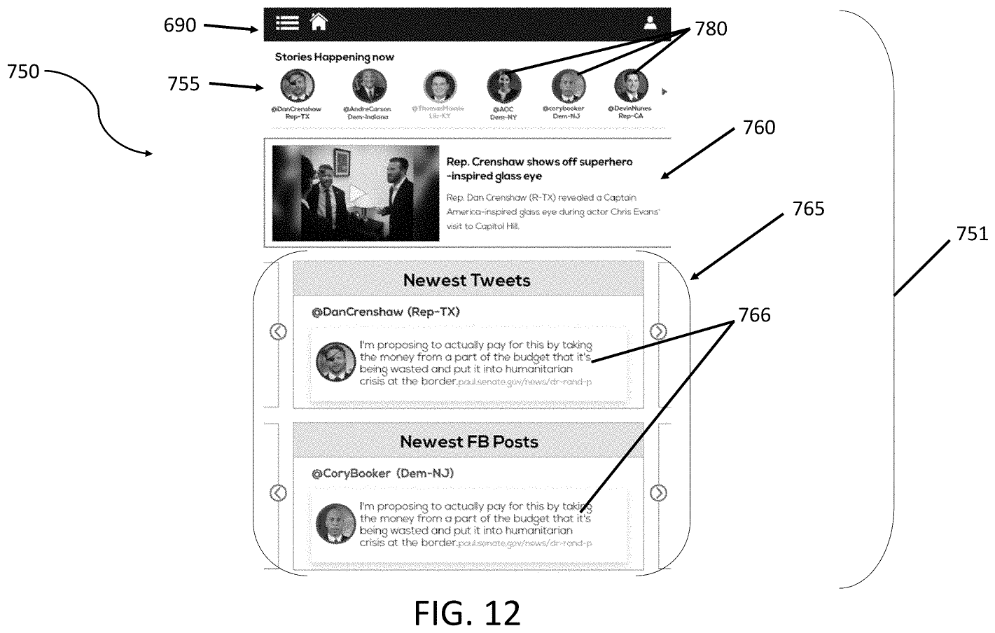

Also shown in FIG. 10 is utility bar 690. In the illustrated embodiment, utility bar 690 is visible and able to be selected by the user at the top of each main screen in the user interface. Utility bar 690 comprises a main menu button 692, a home button 694, and a profile button 696. Selecting main menu button 692 opens the main menu 700 as shown in FIG. 11. Selecting the home button 694 brings the user to home screen 750 as shown in FIG. 12. Selecting the profile button 696 brings the user to profile screen 670. In other embodiments, the utility bar 690 contains other buttons to bring up various screens, or a setting button to alter the settings of the user interface. In another embodiment, the utility bar 690 is “frozen” at the top of the screen and stays in place even as the user scrolls up and down various screens. In yet another embodiment, utility bar 690 only appears when the user scrolls up within the user interface.

Referring now to FIG. 11, main menu 700 is displayed over profile screen 670. When the main menu button 692 is selected, main menu 700 opens over the current screen. Main menu 700 contains a number of buttons for the user to select to bring the user to different screens of the user interface. In the illustrated embodiment, main menu 700 comprises the following buttons: home button 704, edit profile button 706, find friends button 708, connect with others button 710, find representatives button 712, settings button 714, and logout button 716. Home button 704 can bring up home screen 750, edit profile button can bring up either profile screen 670 or profile editing screen 650. Find friends button 708 can bring up the friends screen 800. Connect with others button 710 can bring up connect screen 825. Find representatives button can bring up find representatives screen 875. Settings button 714 can bring up a settings menu or screen (not shown). Logout button 716 can log the user out of communication system 100, and can bring up login screen 600. In other embodiments, main menu 700 can contain more or fewer buttons, and the buttons can bring up screens beyond those described above.

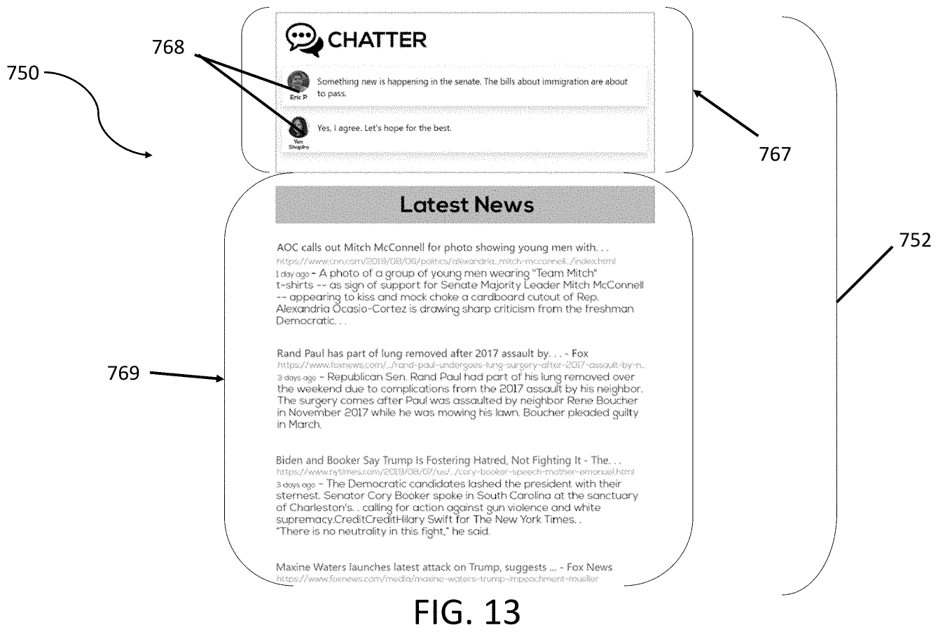

Now referring to FIG. 12, an upper portion 751 of home screen 750 is shown. A user can scroll vertically on home screen 750 to access at least one lower portion 752 of home screen 750 shown in FIG. 13. Home screen 750 contains an overview of news stories, social medio posts, user comments, and general information related to political figures. In one embodiment, home screen 750 only contains information related to the political figures that represent the user, or that the user has selected to follow. In another embodiment, home screen 750 contains information related to all political figures, and is sorted based on popularity across an area or based on user-selected criteria, including topic, location, party, level of government, or other filters. In yet another embodiment, home screen 750 contains information related to all political figures, but is prioritized based on the political figures that represent the user, or that the user has selected to follow.

Home screen 750 comprises a list of political figures 755, the list of political figures 755 comprising individual figure buttons 780. In the illustrated embodiment, figure buttons 780 each represent a political figure, and comprise a picture, name or social media handle, party affiliation, and area of representation (e.g. state, county, city, etc.) for their respective political figure. In other embodiments, figure buttons 780 may comprise different information used to identify each political figure. User may scroll sideways through the list of political figures 755 and may select a figure button 780 to view the political figure screen 900 for the political figure associated with the selected figure button 780. Home screen 750 also comprises a headline section 760. Headline section 760 displays top headlines related to political figures from news sources. Headline section 760 can contain pictures, synopses, videos, and other information related to the headline. Headline section 760 can also include links to third party websites, videos, full articles, and other sources of information. The user may scroll horizontally through headline section 760 to view multiple headlines. In another embodiment, headline section 760 scrolls horizontally through headlines automatically. Home screen 750 also comprises a social media section 765. Social media section 765 displays social media posts 766 made by political figures or related to political figures. In the illustrated embodiment, social media section 765 displays recent social media posts 766 from Twitter and Facebook made by the social media accounts for political figures. Social media section 765 can also contain links to social media websites or accounts, pictures, videos, links to third party websites, or other information. The user may scroll horizontally through social media section 765 to view multiple social media posts 766. In another embodiment, social media section 765 scrolls horizontally through social media posts 766 automatically.

Referring now to FIG. 13, lower portion 752 of home screen 750 comprises a discussion section 767 that displays comments or posts 768 made by users. Users can post messages, pictures, videos, or other forms of communication through live input section 675 or other posting means. In another embodiment, a user can comment on or reply to a post or comment made by another user. Methods and systems for posting, commenting, responding, and otherwise interacting over a social media platform are known in the art. In another embodiment, a user will only see posts made by other users that the user is connected with or friends with or has chosen to follow. In yet another embodiment, a user will see posts made by any other user relating to filtering criteria determined by the user. Home screen 750 also comprises a news section 769 which displays recent news articles related to political figures. Methods and systems for finding and displaying news articles are known in the art. News section 769 can also contain pictures, videos, audio clips, links to third party websites, links to full articles, and other media related to the news.

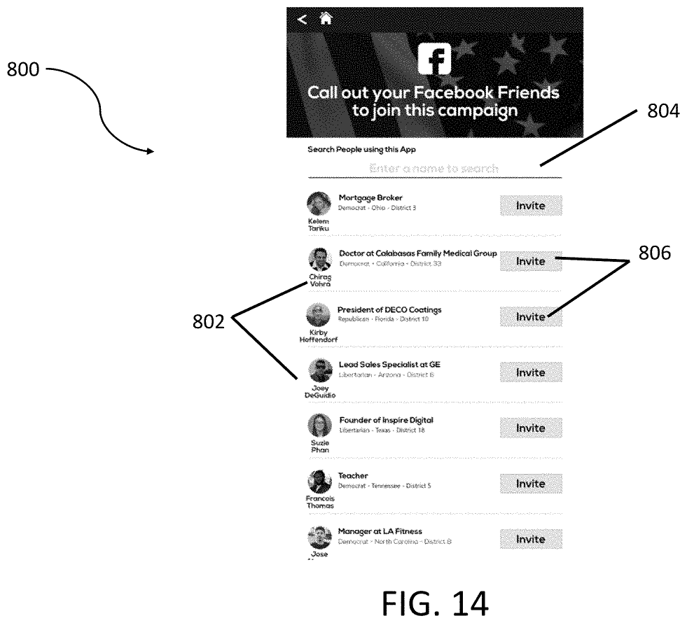

Referring now to FIG. 14, a friends screen 800 is shown. If a user connects their own social media accounts to their account in communication system 100, communication system 100 can receive lists of the user's friends, connections, followers, and other social media connections. Friends screen 800 displays friends, followers, connections, and other social media connections from the user's social media accounts. Friends screen 800 comprises a number of friends 802, a search bar 804, and an invite button 806 for each friend 802. The user can search for friends using search bar 804, or the user can scroll vertically through the number of friends 802. Friends 802 can be displayed with a picture, name, job title, political party, age, location, or other information to identify the friend 802. Furthermore, a user can invite a friend 802 to use the communication system 100 by selecting the invite button 806 associated with the friend 802. Selecting the invite button 806 can send a message to the associated friend 802 to download the user interface, sign up for, or otherwise access communication system 100.

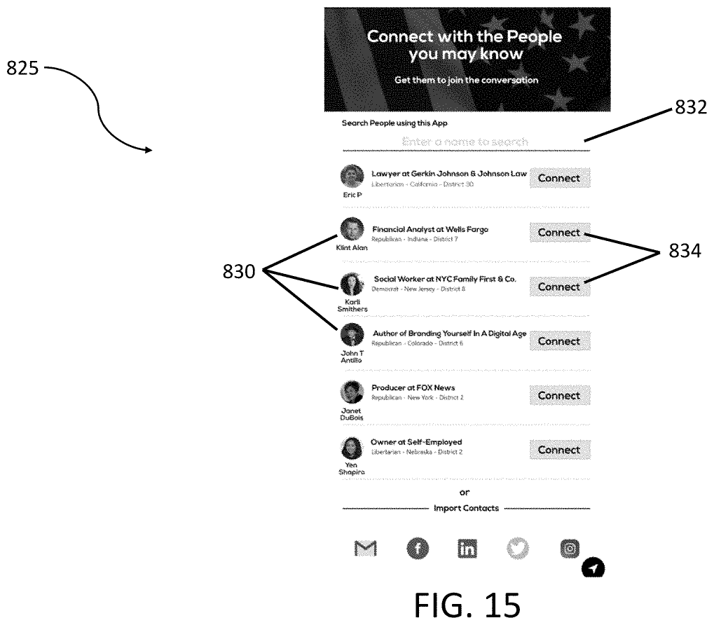

Referring now to FIG. 15, a connection screen 825 is shown. Connection screen 825 allows the user to connect with other users through communication system 100. Connection screen 825 comprises a number of possible connections 830, a search bar 832, and a connect button 834 for each possible connection 830. Each possible connection 830 can contain information to identify the possible connection 830, including a name, picture, job title, location, political party, age, or other identification means. In one embodiment, if two users are connected through communication system 100, the users can send messages to one another, view one another's posts, and generally interact with one another through communication system 100.

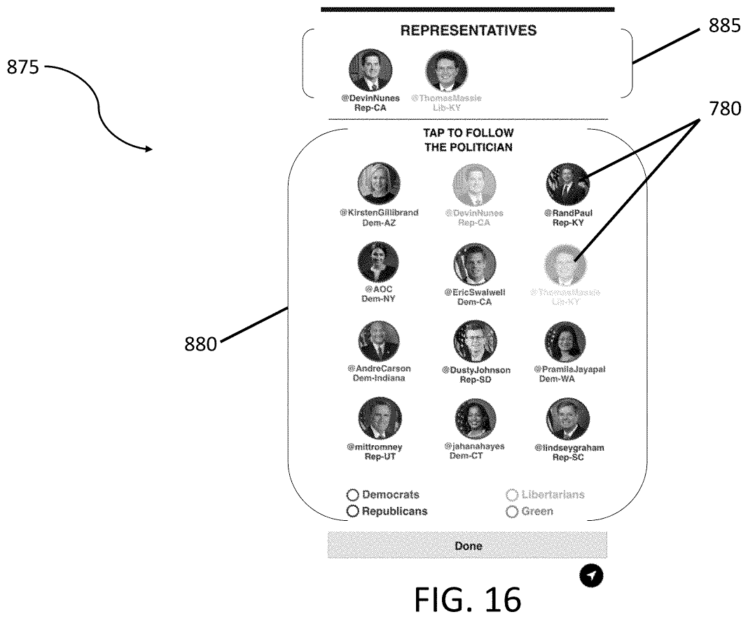

Referring now to FIG. 16, a find representatives screen 875 is shown. The find representatives screen 875 comprises a list of political figures 880 and a selected list of political figures 885. The selected list of political figures 885 can consist of political figures that represent the user, or political figures the user has chosen to follow. Furthermore, the find representatives screen 875 can further comprise a search bar (not shown), and an option to filter the list of political figures 880 by various categories, including political party, office, area, or other criteria. In the illustrated embodiment, each political figure is represented by a figure button 780. The figure button 780 within list of political figures 880 can be visually altered when the political figure is in the selected list of political figures 885. A user can scroll horizontally or vertically through both the list of political figures 880 and the selected list of political figures 885.

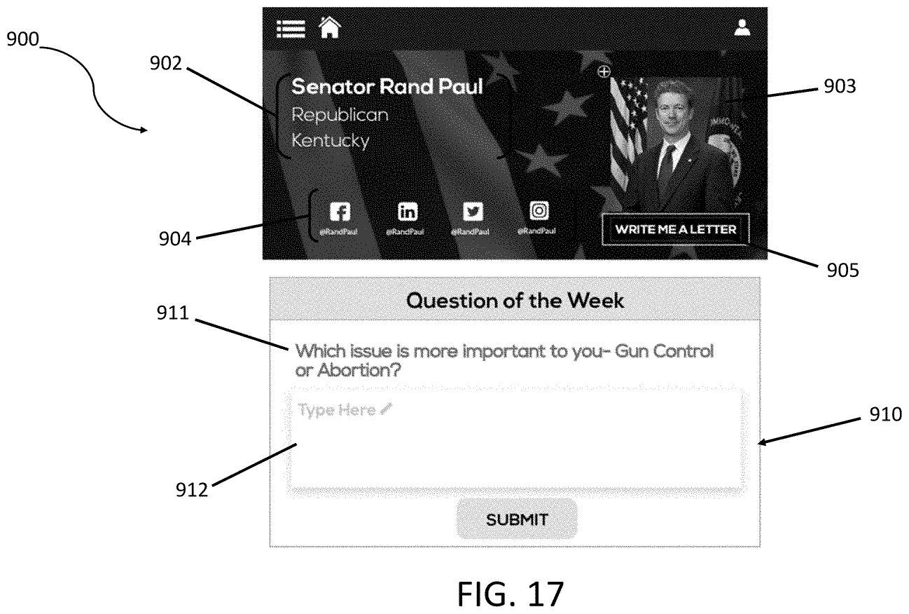

When a user selects a figure button 780, the political figure profile 900 associated with the figure button 780 is brought up. An illustrative embodiment of a political figure profile 900 is shown in FIGS. 17-22. Political figure profile 900 comprises political figure information 902, political figure social media 904, a picture 903, letter button 905, and poll section 910. Political figure information 902 can include the political figure's name, political party, area of representation, office, age, and other identifying information. Political figure social media 904 can include information relating to the social media accounts of the political figure, and can include links to said social media accounts. The letter button 905 can be selected to send a letter to the political figure through method 500 as described above. Poll section 910 comprises a question 911 presented to the user, and a response field 912 for the user to respond to question 911. The question may be generated by the political figure, by a user, or by analysis system 120. In the illustrated embodiment, the response field 912 is a simple text box, but in other embodiments response field 912 may be a checklist, multiple choice buttons, or a dropdown menu. In the illustrated embodiment, the political figure can view the responses entered into the response field 912. In another embodiment, only constituents of the political figure can answer the question 911.

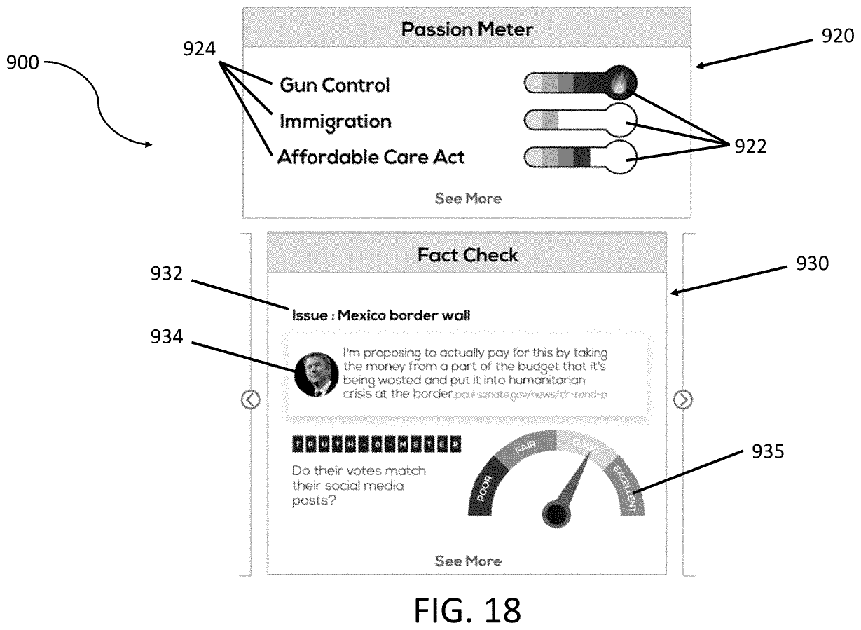

FIG. 18 shows a weighted issue section 920 and a consistency section 930 on political figure profile 900. The weighted issue section 920 displays a list of issues 924 and displays a meter 922 for each issue 924 representing how strongly that candidate feels about the given issue 924. The meters 922 display the weighted issue score calculated from method 300 described above. In the illustrated embodiment, meters 922 are represented as thermometers, and the higher the temperature in the thermometer corresponds to greater passion or care for the issue compared to other issues. In other embodiments, other means of representing how strongly a political figure feels about an issue may be used. Political figure profile 900 also comprises a consistency section 930. Consistency section 930 displays an issue 932 and a meter 935 representing how the political figure's voting record compares to their public stance on the issue 932. Meter 935 is a representation of the consistency score calculated from method 400. In the illustrated embodiment, meter 935 is a gauge with four regions. In other embodiments, meter 935 can be any type of visual indicator, including a scale, thermometer, balance, level, or any other visual means for displaying the consistency score. Consistency section 930 can also display a social media post 934 or other public statement made by the political figure about the issue 932. Consistency section 930 can also display a meter 935 representing the political figure as a whole, and not just over a single issue. Furthermore, consistency section 930 is capable of being scrolled to view multiple issues 932 and their associated meters 935.

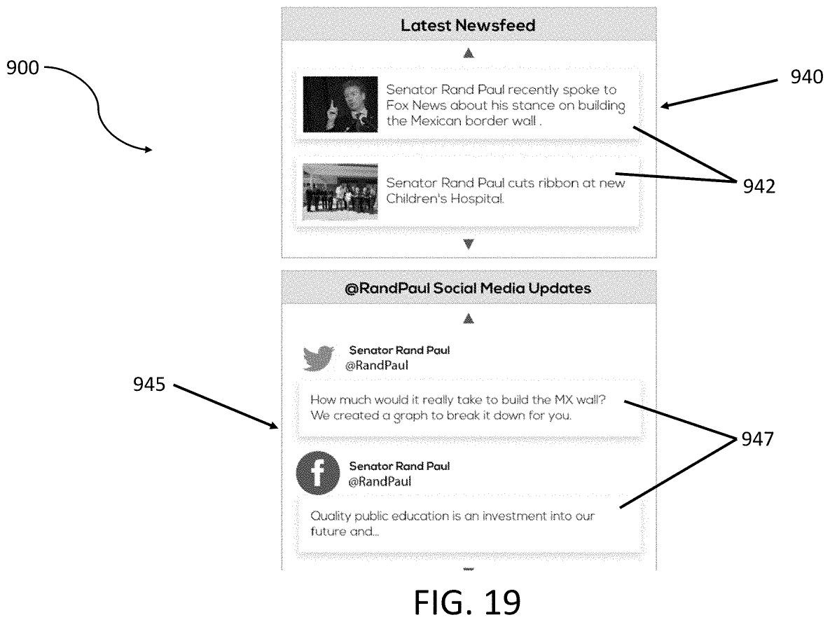

FIG. 19 shows a newsfeed section 940 and a social media section 945 on political figure profile 900. Newsfeed section 940 comprises a number of news stories 942 related to the political figure. News stories 942 can include headlines, summaries, pictures, articles, videos, or other forms of media. Social media section 945 comprises a number of social media posts 947 made by the political figure or about the political figure. Both newsfeed section 940 and social media section 945 are able to be scrolled to view multiple news stories 942 and social media posts 947 respectively.

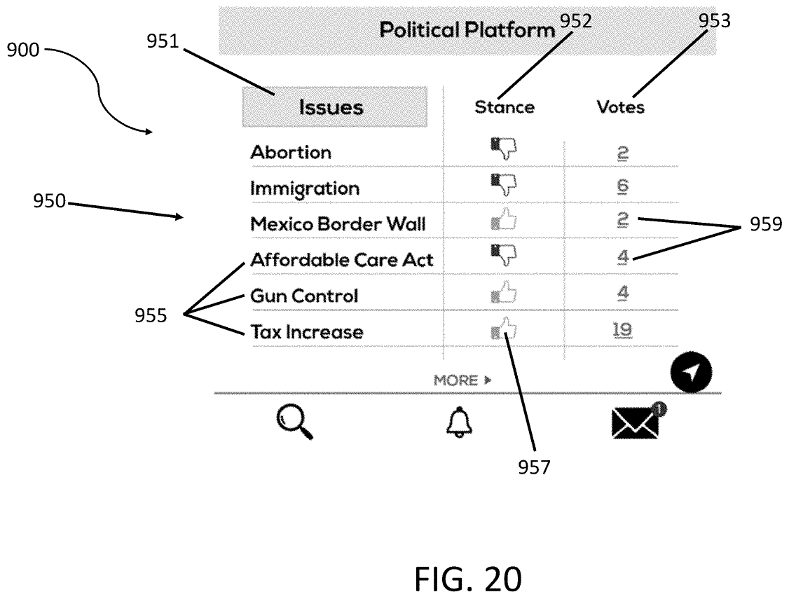

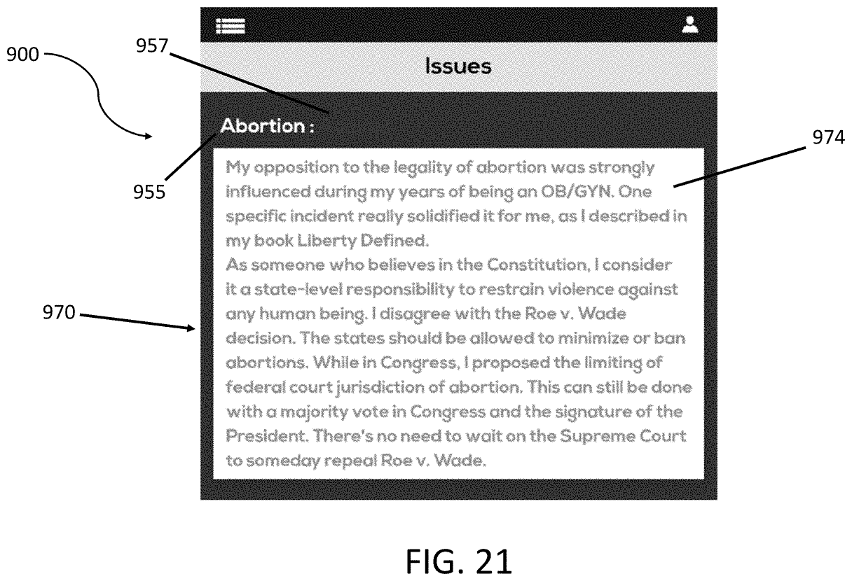

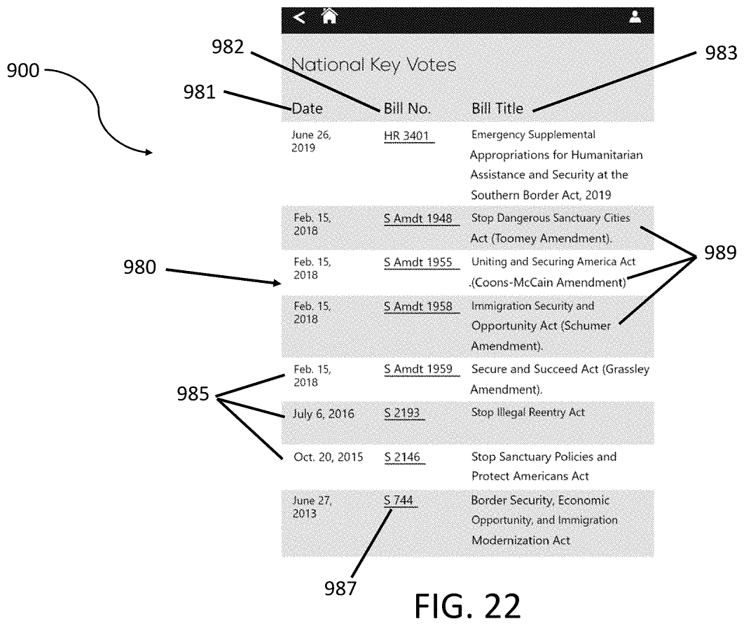

FIG. 20 shows a political stance table 950 on political figure profile 900. Political stance table 950 comprises an issue column 951, a stance column 952, and a vote column 953. The issue column 951 contains a number of issues 955, stance column 952 contains the political figure's stance 957 on the associated issue 955, and the vote column 953 contains the vote record 959 by the political figure related to the associated issue 955. In the illustrated embodiment, issues 955 are single words or phrases representing a political issue. The issues 955 are selectable, and selecting an issue 955 will bring up an issue stance description 970 (Shown in FIG. 21). The political figure's stance 957 on an issue 955 is determined from the figure's weighted issue score on the issue 955 calculated from method 300. The stance 957 in the illustrated embodiment is represented as a color-coded thumbs up or thumbs down to indicate whether or not the political figure is in favor of or opposed to the issue 955. In other embodiments, other visual representations of the stance 957 may be used, including representations that show more than a simple for/against view. The vote record 959 for an issue 955 is determined at least partially from method 400 described above. In the illustrated embodiment, the vote record 959 is selectable, and selecting a vote record 959 will bring up a vote record description 980 (Shown in FIG. 22). In other embodiments, political stance table 950 can also include a consistency column with a representation of the political figure's consistency score for each issue 955.

FIG. 21 shows an issue stance description 970. Issue stance description 970 displays the issue 955, the political figure's stance 957 on the issue, and a detailed description 974 of the political figure's stance 957 on the issue 955. The detailed description 974 can be written directly by the political figure or their staff, or it may be pulled from social media posts, news articles, or other information sources.

FIG. 22 shows a vote record description 980. Vote record description 980 contains a date column 981, a bill number column 982, and a bill title column 983. Each row corresponds to a different bill that was voted on by the political figure. The date column contains a date 985, the bill number columns contains a bill number 987, and the bill title contains the title of the bill 989 for each bill in the vote record description 980. In other embodiments, vote record description 980 can also include a vote column which indicates how the political figure voted on each bill, a description column which provides a brief description of the bill, and/or an issue column which lists the issues included in the bill.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.”

Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

Systems, methods and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic with the benefit of this disclosure in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A computer-implemented method for providing a user with information on political figures that represent the user, the method comprising:
receiving data from a user, the data comprising at least a location of the user and demographic information of the user;
determining at least one first political figure that represents the user in at least one of a local, state, and federal government based on the location of the user and data provided by the at least one of the local, state, and federal government;
identifying through natural language processing at least one key phrase from at least one of social media posts, speech text, and news articles related to the at least one first political figure;
assigning the at least one key phrase to a predetermined issue;
identifying through natural language processing a number of modifying words near the at least one key phrase;
calculating an issue score for the predetermined issue based at least partially on the at least one key phrase and the number of modifying words, wherein the issue score represents the belief of the at least one first political figure about the predetermined issue;
identifying through natural language processing the predetermined issue within a public bill;
determining a voting record of the at least one first political figure on the public bill;
calculating a weighted voting record for the predetermined issue based at least partially on a comparison between the predetermined issue within the public bill and the voting record of the at least one first political figure on the public bill;
generating, by a neural network, a consistency score based at least partially on the issue score and the weighted voting record; and
providing to the user a first graphical display representing the consistency score for the at least one first political figure.

2. The method of claim 1, further comprising the steps of:
selecting by a user at least one second political figure, wherein the at least one second political figure does not necessarily represent the user in at least one of a local, state, and federal government; and
providing to the user a second graphical display representing a consistency score for the at least one second political figure.

3. The method of claim 1, further comprising the step of providing the at least one political figure with the location and demographic information of the user, the demographic information including at least one of the user's name, age, race, ethnicity, gender, voting history, income level, marital status, or political beliefs.

4. The method of claim 1 further comprising the steps of:
displaying at least one question to the user related to a political issue;
receiving a response to the question from the user;
displaying the response to the at least one first political figure.

5. The method of claim 1, wherein the issue score comprises at least one scale value representing whether the at least one first political figure is outwardly positive or negative towards the predetermined issue, and at least one magnitude value representing how strongly the at least one first political figure outwardly presents their opinions on the predetermined issue.

6. The method of claim 5, wherein the at least one scale value ranges from negative one to positive one, and the at least one magnitude value is a positive integer.

7. The method of claim 1, further comprising the steps of:
providing the user with a text template;
receiving a number of edits to the text template from the user to create a final text;
printing the final text onto a physical medium; and
sending the physical medium with the final text to the at least one first political figure.

8. The method of claim 1, further comprising the step of providing the user with a second graphical display representing the issue score.

9. The method of claim 8, wherein the second graphical display is a thermometer.

10. A computer-implemented method for providing communication between a user and a political figure, the method comprising:
providing the user with a number of information entry fields;
receiving from the user a first set of information in the number of entry fields, the first set of information including at least one of the user's name, location, political party, and gender;
storing the first set of information in a database;
generating a user account for the user, wherein the user account is associated with the first set of information;
selecting by the user at least one political figure;
providing to the user a profile for the at least one political figure;
providing to the user a question from the at least one political figure;
receiving a response from the user to the question, and sending the response to the at least one political figure;
receiving a message from the at least one political figure, the message comprising at least one of text, video, and audio;
displaying the message to the user; and
displaying at least one meter to the user in the profile for the at least one political figure, the at least one meter representing at least one of a consistency score and a weighted issue score for the at least one political figure, wherein the consistency score and weighted issue score are calculated by a neural network algorithm based on information from a number of social media posts related to the at least one political figure.

11. The method of claim 10, further comprising the step of sending to the at least one political figure a physical letter, wherein the physical letter comprises text at least partially taken from a template.

12. The method of claim 10, further comprising the step of displaying an issue table on the user profile for the at least one political figure, the issue table comprising a number of issues and a stance and a vote number associated with each issue.

13. The method of claim 12, wherein the issue is selectable, and selecting the issue provides the user with an issue description, the issue description containing information related to a stance of the at least one political figure related to the issue.
